(19) United States
(12) Patent Application Publication
(10) Pub. No.: US 2016/0258500 A1
(43) Pub. Date: Sep. 8, 2016

(54) Brake Disc Mounting Arrangement

(71) Applicant: Bendix Spicer Foundation Brake LLC, Elyria, OH (US)

(72) Inventor: Manouchehr SABETI, North Olmstead, OH (US)

(21) Appl. No.: 14/640,152

(22) Filed: Mar. 6, 2015

(51) Int. Cl. F16D 65/12

(52) U.S. Cl. CPC F16D 65/123; F16D 2065/1384

(57) ABSTRACT

An arrangement and method for mounting a brake disc to an axle hub of a vehicle is provided. The arrangement includes wedge-shaped holes at an radially inner region of the brake disc, corresponding wedge-shaped key inserts, a retaining device such as a retaining ring, and mounting devices such as bolts or studs and nuts that pass through the retaining ring and keys to bias the keys against the axle hub. The circumferential sides of the wedge shapes are aligned with radial lines extending from the rotation axis of the axle hub. This arrangement and method provides a simple, robust and easily installed brake disc mounting that minimizes heat transfer between the brake disc and the axle hub and accommodates thermal expansion of the brake disc and the axle hub to minimize thermal expansion-induced stresses to the brake disc.

### BACKGROUND AND SUMMARY OF THE INVENTION

The present invention relates to disc brakes for vehicles, and in particular to an arrangement for connecting a brake disc to an axle hub, including axle hubs utilized on commercial vehicles such as tractor-trailer trucks, box trucks, buses, and the like. The invention also relates to a method for installation of a brake disc on an axle hub.

Disc brakes are increasing being used on commercial vehicles, replacing conventional drum brakes. Very high braking energy is generated when the disc brake's caliper applies the brake pads to the brake disc to slow such heavy vehicles. In order to deal with such loads, very robust and often complicated designs have been required to connect the brake disc of a disc brake to transfer the braking forces from the brake disc to the axle hub on which the brake disc is mounted. The design of the brake disc-to-hub connection is further complicated by the heat generated during braking as the kinetic energy of the vehicle is converted into heat energy by application of the brake pads to the brake disc. The heat the hub receives from the brake disc can be detrimental to the axle hub and its components (such as bearings and seals), as well as causing high component stresses due to differences in thermal expansion between different materials (for example, between an aluminum hub and a steel brake disc), causing brake fade and contributing to premature failure of braking components.

Commercial vehicle brake discs, also referred to as “brake rotors” or “rotors,” often are mounted onto axle hubs using so-called spline arrangements using a fixed or floating connection, such as taught in U.S. Pat. Nos. 6,626,273 and 7,410,036. One example a semi-floating connection is the Splined Disc® brake assembly from Bendix Spicer Foundation Brake LLC. These types of brakes typically are mounted on an axle hub having a plurality of axially-oriented splines arranged around an outer circumference of a disc-mounting region of the hub. The brake disc has corresponding radially-inward facing tabs about the inner circumference of the brake disc. The disc is mounted to the axle hub by axially sliding the brake disc onto the hub's mating splines, followed by insertion and/or attachment of a variety of fasteners, brackets, etc., as necessary per the particular splined disc's design in order to secure the brake disc against axial movement off of the hub. When so mounted, the brake disc's tabs engage the hub's splines in a manner which permits the very large braking forces generated by the disc brake to be transferred to the axle hub and hence to the axle to slow the vehicle. This often requires costly precision machining of the spline/tab engagement surfaces.

Splined discs typically have had substantial metal-to-metal contact between the inner radial tabs of the brake disc and either the faces of the axle hub splines or intermediary inserts that are used to transfer the braking loads from the disc tabs to the hub splines. The intermediate inserts are used in conjunction with hub axial stop to axially restrain the brake disc on the axle hub. This metal-to-metal contact has the disadvantage of facilitating transfer of a large amount of brake heat from the brake disc directly to the axle hub. This is a particular problem where the axle hub is formed from aluminum, a material which is being more frequently used for axle hubs in order to minimize vehicle weight and improve fuel economy, as the aluminum of the axle hub and the material of the brake disc (typically cast iron) have significantly different thermal expansion coefficients.

Other brake disc amounting arrangements are known which fix the brake disc to a hub or only allow limited relative movement between the brake disc and the hub. Such arrangements can inhibit the radial expansion of the brake disc, hub and connecting elements, leading to problems such as brake disc deformation (for example, “coning” of the brake disc, in which the friction surfaces of the brake disc bend out of a plane perpendicular to the axle hub's rotation axis). Such deformations can decrease brake disc and brake pad life, and cause brake disc “cracking” due to deformation-induced tensile stress.

In order to address these and other problems with brake disc mounting in the prior art, the present invention provides a disc mounting arrangement that accommodates differential radial growth of the axle hub and the brake disc, minimizes the number of individual intermediary disc-to-hub elements, is simple to assemble and disassemble during installation and/or replacement of the brake disc, and is highly cost effective.

In one embodiment of the invention a brake disc is provided with a plurality of wedge-shaped slots about and inner circumference of the brake disc. The brake disc slots are radially positioned in locations corresponding to brake disc mounting studs provided on an axle hub. The brake disc and the hub are connected to one another by wedge-shaped elements (aka “keys”) that are positioned in corresponding transverse wedge-shaped holes in a radially inner region of the brake disc, preferably with a retaining device that retains the keys in their respective holes in the brake disc. The keys are provided with an aperture that can pass over a respective brake disc mounting stud, and with side surfaces that conform to the inner surfaces of the wedge-shaped brake disc holes. The keys may be formed from any material that can withstand the forces and temperatures encountered during braking events in this region of the hub and brake disc, for example, preferably a stainless steel material to minimize corrosion in the harsh axle hub environment.

The brake disc and keys in this embodiment are axially retained on the hub by a retaining device in the form of a bolting ring having holes to receive the brake disc mounting studs, and secured by fasteners such as nuts that bias at least the keys against the axle hub. The keys maintain adequate gap with the wedge slots to maintain the space required for the free thermal expansion of the rotor.

Preferably the sides of the wedge-shaped keys and their respective brake disc holes have their circumferential sides (the sides between their radially inner and radially outer sides that are approximately parallel to the hub rotation axis), aligned in the direction of radii extending from the hub rotation axis. Arranging the key and hole sides in this manner facilitates cooperative movement of the keys in their holes during simultaneous thermal expansion of the hub and the brake disc, thereby minimizing the potential for jamming between the keys and the brake disc and resulting development of thermally-induced stresses in the hub/disc system. Other geometries are possible as the wedge geometry is a function of the thermal mass of the rotor (the heat source) and the vane structure (dissipating heat).

In the disc attachment arrangements of the present invention, any suitable fastener arrangement between the hub and the retaining device is possible, as long as the brake disc remains axially captured while in the installed position. For example, the hub-mounted studs and nuts in the foregoing embodiment may be replaced by bolts that pass through the retaining device and keys into holes in the axle hub.

Preferably, the keys are sized in the axial direction such that they are firmly biased against the hub at all times. The holes in keys through which fasteners pass preferably are sized near the size of the outer diameter of the fastener in order to maximize the load-bearing surface contact between the keys and the fasteners.

The brake disc may in the radially inner region containing the transverse wedge-shaped holes have a thickness that is either less than or equal to the axial thickness of the keys. A brake disc with a thickness in this region that is less than that of the keys may be a so-called floating disc, i.e., a brake disc that is capable of small axial movement to accommodate braking forces and heat-related expansion during braking events. This arrangement also helps minimize the amount of direct brake disc-to-hub contact area, helping further minimize direct brake disc-to hub heat transfer and consequent hub temperature increases.

Further preferably, the keys may be circumferentially spaced around the brake disc at spacings that complement or enhance the flow of cooling air from the hub region through brake disc internal vane structures to the radially outer region of the brake disc.

The present brake disc mounting arrangement is particularly simple and easy to install and/or replace. An embodiment of a method of installation includes locating a brake disc on an axle hub with the brake disc's wedge-shaped holes aligned with the hub's mounting studs or fastener-receiving holes, inserting corresponding wedge-shaped keys into the brake disc's wedge-shaped holes, placing a bolting ring over the keys, and installing fasteners that bias the keys against the hub. The keys allow the rotor to be piloted on the hub. Other variations are possible, for example, the keys may be located in the brake disc holes before the brake disc is located on the axle hub, or the fasteners may be fed through the keys before the keys are located in their respective brake disc holes.

Other objects, advantages and novel features of the present invention will become apparent from the following detailed description of the invention when considered in conjunction with the accompanying drawings.

### BRIEF DESCRIPTION OF THE DRAWINGS

FIG. 1 is an oblique expanded view of a brake disc mounting arrangement in accordance with an embodiment of the present invention.

FIG. 2 is an elevation view of the arrangement of mounting holes of the brake disc and the respective mounting keys of the FIG. 1 embodiment.

FIGS. 3A and 3B are elevation views of the arrangement of one of the brake disc mounting holes and its respective mounting key of the FIG. 1 embodiment.

FIG. 4 is a view of another embodiment of a retaining device in accordance with an embodiment of the present invention.

FIG. 5 is an elevation view of the arrangement of one of the brake disc mounting holes and its respective mounting key of another embodiment of the present invention.

Common reference label numbers are used with common features in the figures.

### DETAILED DESCRIPTION OF THE DRAWINGS

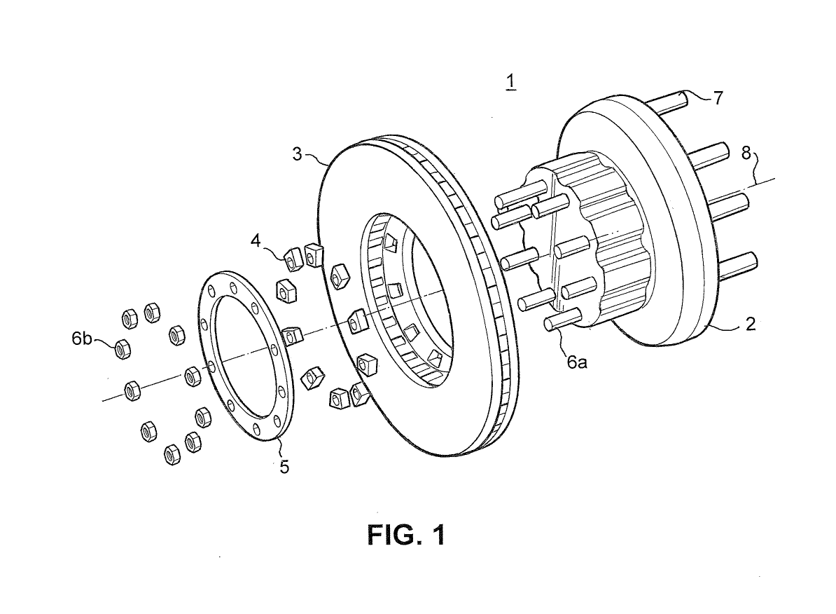

FIG. 1 illustrates a brake disc mounting embodiment 1 including a rotating axle hub 2 located on an end of a vehicle axle (not illustrated), a brake disc 3, wedge-shaped keys 4, a retaining ring 5 and studs 6a and corresponding retaining members, nuts 6b. In this embodiment, the brake disc is located on a side of the axle hub 2 opposite the hub side facing a wheel (not illustrated) that would be secured to the hub 2 on wheel studs 7. The corresponding retaining members may be other than the nuts 6, for example as clips or split pins, as long as the retaining members maintain a biasing force to bias the keys 4 against the axle hub 2. The key can be any shape but the wedge shape must be in the slot. If the key is not wedge shaped, a spring may be used to bias the key in the wedge shaped slot. The keys may also be integrated with the retaining ring, and the ring may be shaped to provide protection against intrusion of material such as liquids or solid debris that might lead to corrosion or other blockage that could prevent relative movement between the brake disc 3 and the keys 4.

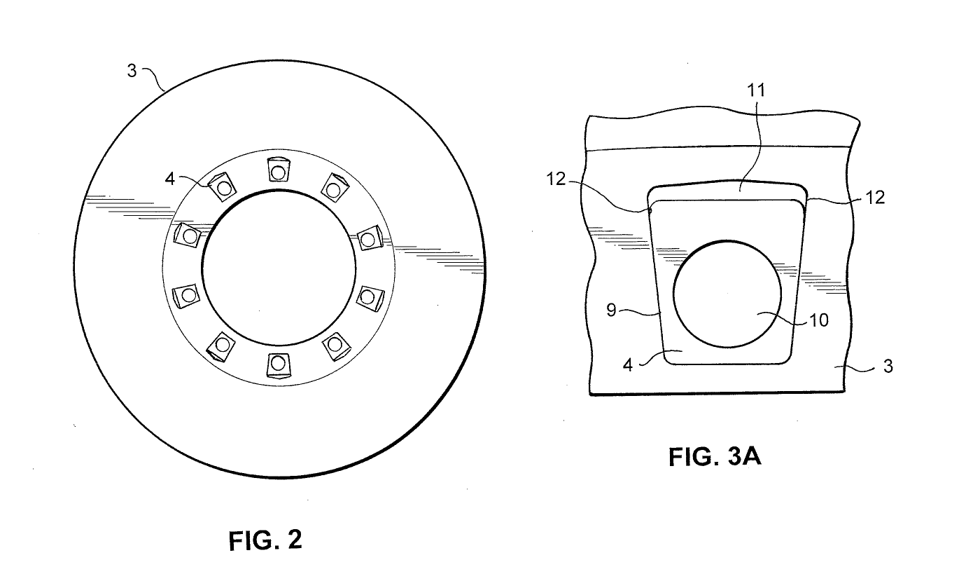

FIGS. 2 and 3A-3B show elevation views of an axial face of one of the keys 4 and the brake disc 3's corresponding transversely aligned (i.e., aligned parallel to the hub rotation axis 8) wedge-shaped holes 9 that is configured to receive the key 4. Visible in FIGS. 3A-3B is the hole 10 in the key 4 through which the fastener stud 6a passes, and the gap 11 provided on the radially outer side of the key 4 hole to accommodate relative motion between the key 4 and the brake disc hole 9 as the hub and the brake disc thermally expand during a braking event. The effects of thermal expansion are illustrated in FIGS. 3A-3B by the movement of the key 4 relative to the hole 9, with FIG. 3A illustrating a maximum thermal expansion state and FIG. 3B illustrating a minimum thermal expansion state. The holes 10 in the keys 4 is not limited to being located at a center of the keys or being a round shape, as long as the keys 4 can transfer braking forces from the brake disc 3 to the axle hub 2. The keys 4 are also not limited to being one-piece keys. For example, multi-part keys may be used, such as two symmetrical keys each forming one-half of the wedge-shape corresponding to the wedge-shape of a brake disc hole 9, as long as the keys can transfer braking forces from the brake disc 3 to the axle hub 2. Similarly, as shown in the example in FIG. 5, the key 4 may be biased against a side of the brake disc hole 9 by a biasing element 13, such as a leaf spring.

The circumferential sides 12 of the key 4 are disposed along radial lines having their origins at the rotation axis 8 of the hub 2, such that during heating from a braking event the radially outward expansion of the brake disc 3 and the hub 2 (and to a typically negligible extent, of the key 4) occurs such that the line of contact between the brake disc 3 and the key 4 at the sides 12 remains generally aligned with the radial lines. This arrangement allows the brake disc 3 and key 4 in the region of sides 12 to expand or move radially outward while simultaneously accommodating expansion of the brake disc 2 and the key 4 in the circumferential direction at sides 12 in a manner that avoids binding between these components, even when the hub 2 and the brake disc 3 are formed from different materials such as aluminum and cast iron. The gap 11 at the radially outer side of the key 4 may be sized to accommodate a particular combination of hub and brake disc materials, or may be sized in a “worst case” manner to accommodate any likely combination of hub and brake disc materials.

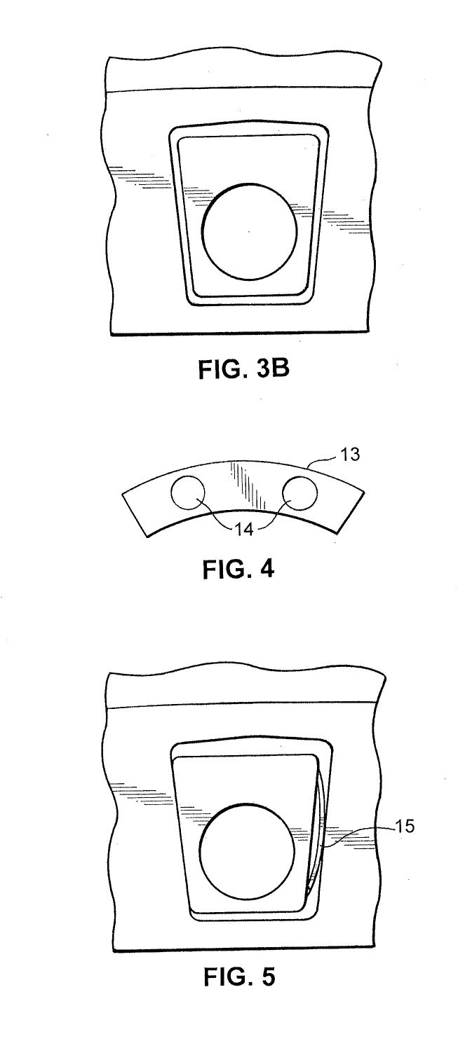

The FIG. 1 retaining ring 5 does not need to be formed as one-piece component. For example, the retaining device may be formed by a plurality of plates, as long as each plate overlaps at least one key and a portion of the brake disc immediately adjacent to the key so that the brake disc remains axially constrained (either floating or rigidly mounted) on the hub. An example of such a plate is illustrated in FIG. 4, where retaining plate 13 is an arc-shaped segment with two holes 14 to receive fasteners that pass through the corresponding key holes 10. As noted above, the plate 13 may cover more than two keys 4 or only one key 4, as long as the plate overlaps both the key(s) and adjacent portions of the brake disc to axially secure the brake disc.

Biasing elements 15 may be located on one or more of the four sides of the key facing the brake disc, i.e., the key's radially inner side, radially outer side and/or one or both circumferential sides.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

Listing of Reference Labels:

1 brake disc mounting arrangement

2 axle hub

3 brake disc

4 wedge-shaped key element

5 retaining ring

6a fastener stud

6b fastener nut

7 wheel stud

8 axle hub rotation axis

9 wedge-shaped brake disc hole

10 key fastener pass-through hole

11 radial gap

12 key-brake disc circumferential sides

13 retaining plate

14 retaining plate holes

15 biasing elements

What is claimed is:

1. A brake disc mounting arrangement, comprising:
an axle hub having a rotation axis;
a brake disc having a plurality of holes arranged circumferentially about a radially inner region of the brake disc;
a plurality of keys, each key being configured to be located in a corresponding one of the plurality of brake disc holes and to receive a brake disc mounting device; and
a retaining device arranged to cooperate with the brake disc mounting devices to bias the plurality of keys against the axle hub when the brake disc is located between the retaining device and the axle hub,
wherein, when in an installed position on the axle hub, each of the plurality of keys and the plurality of brake disc holes has circumferential sides aligned along a respective radial line, each radial line having an origin at the axle hub rotation axis.

2. The brake disc mounting arrangement of claim 1, wherein
the disc brake mounting devices include at least one of fasteners configured to cooperate with the retaining device and the axle hub to retain the plurality of keys and the brake disc on the axle hub, and studs located on the axle hub with corresponding retaining members configured to cooperate with the retaining device and the axle hub to retain the plurality of keys and the brake disc on the axle hub.

3. The brake disc mounting arrangement of claim 2, wherein
the corresponding retaining members are threaded nuts.

4. The brake disc mounting arrangement of claim 2, wherein
the retaining device is at least one retaining plate configured to extend over at least a portion of an axial face of the one of the plurality of keys facing away from the axle hub and over a portion of the brake disc adjacent to the one of the plurality of keys such that the brake disc is axially restrained on the axle hub.

5. The brake disc mounting arrangement of claim 4, wherein
the at least one retaining plate is a retaining ring.

6. The brake disc mounting arrangement of claim 1, further comprising:
at least one biasing element configured to be positioned between the brake disc and at least one circumferential and/or radial face of at least one of the plurality of keys.

7. The brake disc mounting arrangement of claim 1, wherein
a gap exists between the brake disc and at least one circumferential and/or radial face of the at least one of the plurality of keys.

8. The brake disc mounting arrangement of claim 7, wherein
the gap exists between the brake disc and all of the circumferential and radial faces of the at least one of the plurality of keys.

9. A method for mounting a brake disc on an axle hub, the axle hub having a rotation axis, the brake disc having a plurality of holes arranged circumferentially about a radially inner region of the brake disc, comprising the acts of:
locating one of the brake disc and a plurality of keys configured to be located in a corresponding one of the plurality of brake disc holes on the axle hub;
locating the other of the brake disc and a plurality of keys on the axle hub with the plurality of keys located in the plurality of brake disc holes;
locating a retaining device over at least a portion of an axial face of the one of the plurality of keys facing away from the axle hub and over a portion of the brake disc adjacent to the one of the plurality of keys such that the brake disc is axially restrained on the axle hub; and
securing the retaining device to the axle hub with at least one brake disc mounting device such that the plurality of keys are biased against the axle hub by the retaining device,
wherein, when in an installed position on the axle hub, each of the plurality of keys and the plurality of brake disc holes has circumferential sides aligned along a respective radial line, each radial line having an origin at the axle hub rotation axis.

10. The method of claim 9, wherein
the at least one disc brake mounting device includes at least one of at least one fastener configured to cooperate with the retaining device and the axle hub to retain the plurality of keys and the brake disc on the axle hub, and at least one stud located on the axle hub with at least one corresponding retaining member configured to cooperate with the retaining device and the axle hub to retain the plurality of keys and the brake disc on the axle hub.

11. The method of claim 10, wherein
the at least one corresponding retaining member is a nut.

12. The method of claim 10, wherein
the retaining device is at least one retaining plate configured to extend over at least a portion of an axial face of the one of the plurality of keys facing away from the axle hub and over a portion of the brake disc adjacent to the one of the plurality of keys such that the brake disc is axially restrained on the axle hub.

13. The method of claim 12, wherein
the at least one retaining plate is a retaining ring.

14. The method of claim 9, further comprising the act of:
positioning at least one biasing element between the brake disc and at least one circumferential and/or radial face of at least one of the plurality of keys.

15. A brake disc mounting arrangement, comprising:
a brake disc having a rotation axis and a plurality of holes arranged circumferentially about a radially inner region of the brake disc;
a plurality of keys, each key being configured to be located in a corresponding one of the plurality of brake disc holes and to receive a brake disc mounting device; and
a retaining device arranged to cooperate with the brake disc mounting devices when the brake disc is located on an axle hub to bias the plurality of keys against the axle hub,
wherein each of the plurality of keys and the plurality of brake disc holes has circumferential sides aligned along a respective radial line, each radial line having an origin at the brake disc rotation axis.
